(19) United States
(12) Patent Application Publication
(10) Pub. No.: US 2013/0270285 A1
(43) Pub. Date: Oct. 17, 2013

(54) POT LID HANDLE

(71) Applicant: Mark Stratmeyer, Thousand Oaks, CA (US)

(72) Inventor: Mark Stratmeyer, Thousand Oaks, CA (US)

(21) Appl. No.: 13/803,899

(22) Filed: Mar. 14, 2013

Related U.S. Application Data
(60) Provisional application No. 61/618,596, filed on Mar. 30, 2012.

(51) Int. Cl. A47J 45/06

(52) U.S. Cl. CPC A47J 45/06
USPC 220/755

(57) ABSTRACT

A unique designed, larger handle for a pot lid extends a greater distance above the lid central surface than in prior lid handles. As a result, the larger pot lid handle provides to a user the ability to grasp the handle when the pot lid with handle oriented downward is resting on a surface without burning the users hand on the hot pot lid. When the pot lid with the new handle is placed on a flat surface with said handle extended toward and in contact with the surface, and a surface portion of the pot lid is in contact with said surface, this handle design results in the pot lid resting at a much greater angle to said surface than in state of the art pot lid handle designs.

Benefit is claimed of Provisional Application Ser. No. 61/618,596 filed Mar. 30, 2012.

The product described below relates to kitchen utensils, more particularly pot lids and the handles used on those pot lids.

### BACKGROUND

FIGS. 1 and 2 show a standard pot 10, such as a sauce pan, with a lid 12 and a handle 14 attached to the lid 12. FIG. 2 shows the pot lid 12 removed from the pot 10 and set on a surface 16 upside down with the lid 12 resting on an angle, an edge of the lid 12 and the handle 14 contacting the surface. If it is not placed upside down and is instead placed with the inner surface of the lid downward, the lower surface of the lid 12 could become contaminated from dirt on the counter top surface 16 on which it is placed. Once placed upside down, because of the small angle between the lid and the surface, it is difficult to grasp the handle 14 to place the lid 12 back on the pot 10 without the user being burned by the down-facing surface of the hot lid.

### BRIEF DESCRIPTION OF THE DRAWINGS

FIG. 1 is a side view of a sauce pan with a lid and a prior art lid handle.

FIG. 2 is a side view of the prior art lid of FIG. 1 with the handle in an upside down orientation resting on a counter surface.

FIG. 3 is a front perspective view of a first embodiment of a lid handle incorporating features of the invention mounted on the top of a lid.

FIG. 4 is a front view of the first embodiment of a lid with the handle shown in FIG. 3.

FIG. 5 is a top view of the first embodiment of a lid with the handle shown in FIG. 3.

FIG. 6 is a front view of the first embodiment of a lid with the handle as shown in FIG. 3 mounted on a smaller diameter lid.

FIG. 7 is a front perspective view of a second embodiment of a lid handle incorporating features of the invention mounted on the top of a lid.

FIG. 8 is a side view of the second embodiment of a lid with the handle shown in FIG. 7.

FIG. 9 is a top view of the second embodiment of a lid with the handle shown in FIG. 7.

FIG. 10 is a front view of the second embodiment of the lid handle as shown in FIG. 7 mounted on a smaller diameter lid.

FIG. 11 is a side view showing for comparison purposes, as subviews a, b, c, and d, the lid and handle arrangement as shown in each of FIGS. 3, 6, 7 and 10 resting at an angle on a flat surface.

FIG. 12 is a perspective view of a variation of the handle shown in FIGS. 3-6.

FIG. 13 is a perspective view of a variation of the handle shown in FIGS. 7-10.

### DETAILED DESCRIPTION

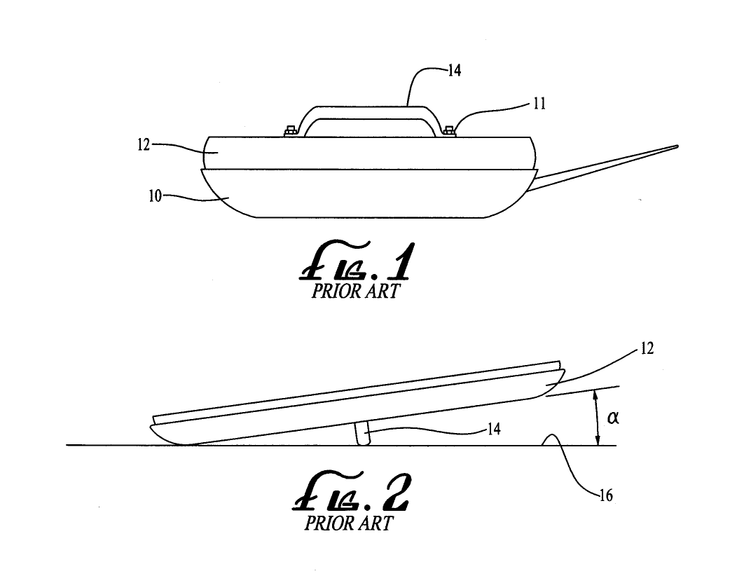

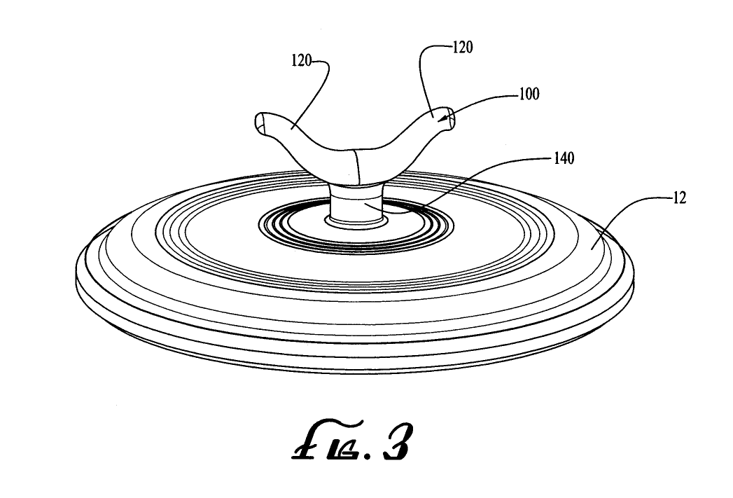

FIGS. 1 and 2 show a typical prior art pot lid. Irrespective of the diameter of the lid, a typical handle extends approximately 1-2″ above the lid surface. When the lid is resting on a surface with the handle downward a typical angle between the lid and the surface is less than about 15° typically about 10° as represented by a in FIG. 2. As such, it is very difficult for an individual to reach her hand under the upside down lid to grasp the lid handle without the hand coming in contact with the hot lid surface. Further, since the lid handle usually provides only a single point of contact with the surface, the upside down lid will frequently roll around that point of contact, thus repositioning the position of the lid on the surface. Both of these issues are addressed by the lid structure shown and described herein.

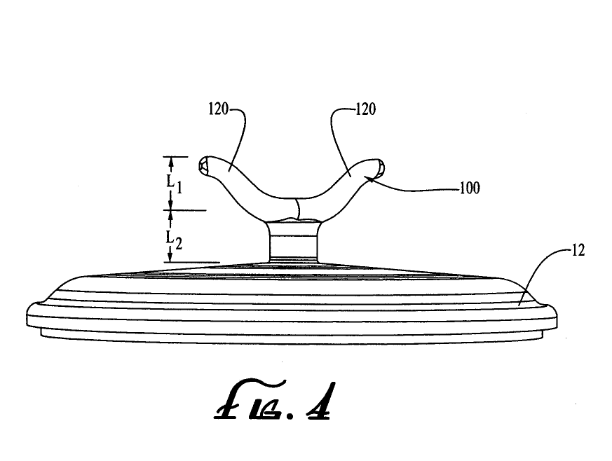

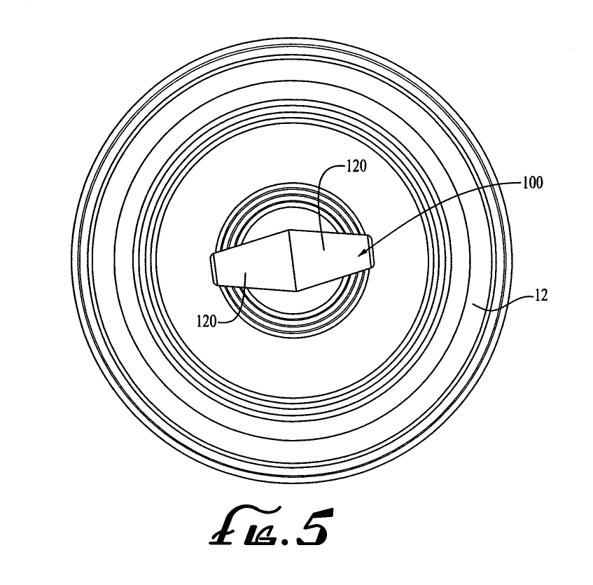

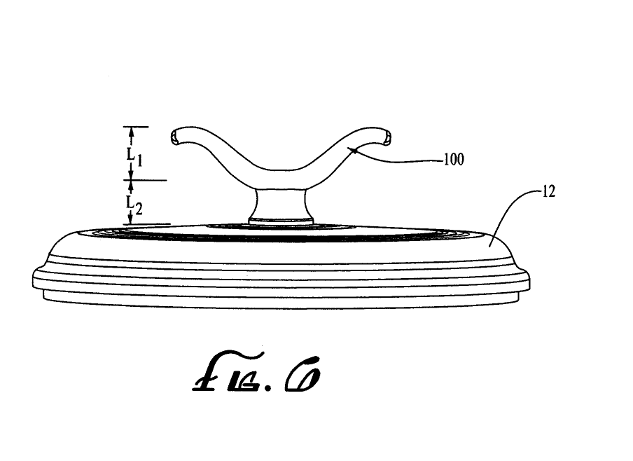

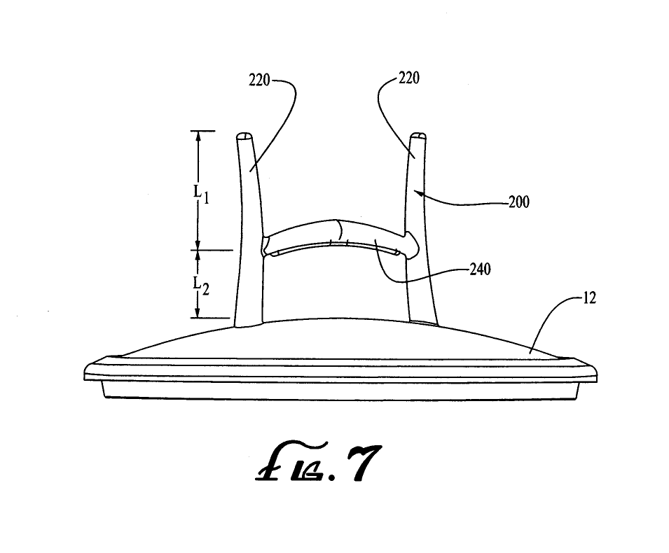

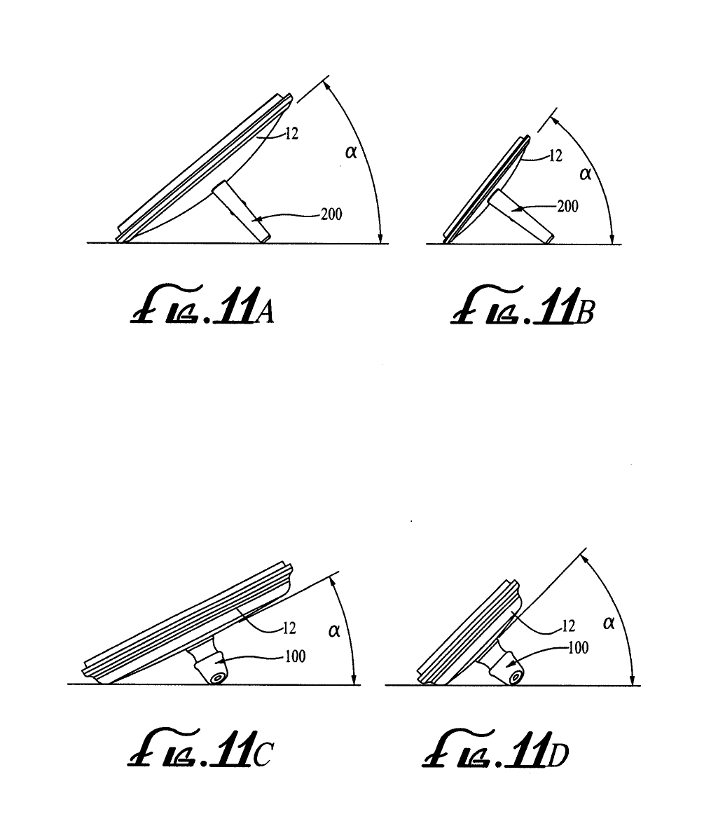

FIGS. 3-6 show a first embodiment of a lid handle 100 incorporating features of the invention. In particular the lid handle 100 includes two extensions 120 which protrude from and extend above the center portion 140 of the handle. When the lid 12 is removed from the pot 10 and is placed upside down on a surface 16 with the lid 12 resting at an angle a formed by an edge of the lid 12 and the ends of the two extensions 120 on the handle contacting the surface 16, due to the greater angle a as shown in FIG. 11, the handle 100 can be once again readily grasped by the center portion 24 of the handle, the lid can be lifted without contacting the hot surface of the lid 100. FIG. 6 shows the same handle 100 on a smaller diameter lid 12.

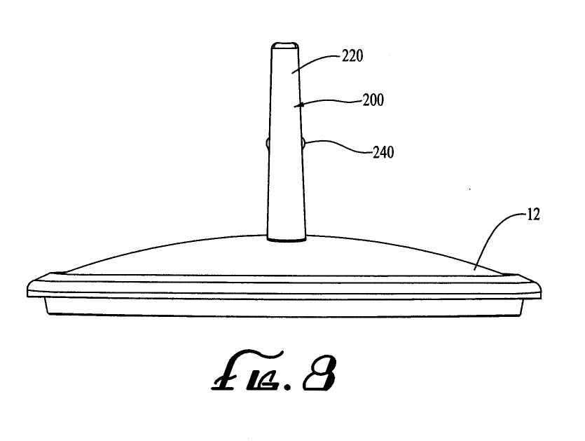

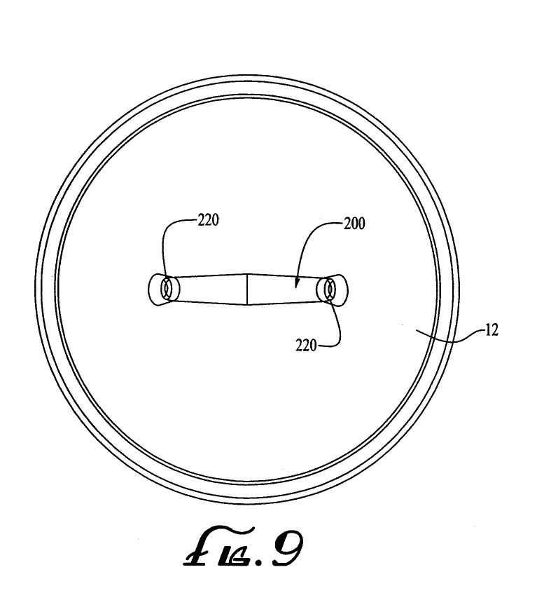

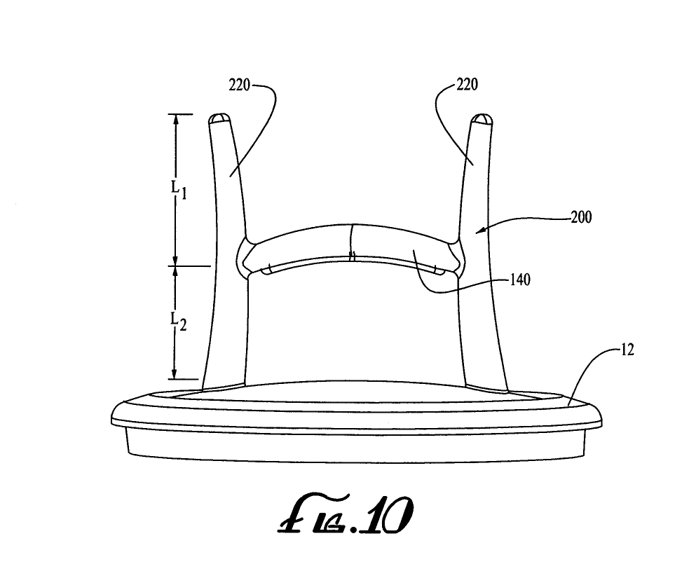

FIGS. 7-10 show a second embodiment of a lid handle 200 incorporating features of the invention. In particular, the lid handle 200 includes two extensions 220 which extend above the center portion 240 of the handle. When the lid 12 is removed from the pot 10 and is placed upside down on a surface 16 with the lid 12 resting at an angle a formed by a surface portion of the lid 12 and the ends of the extensions 220 on the handle contacting the surface 16, because of the greater angle a, as shown in FIG. 11, the handle can be once again be grasped by the center portion 240 of the handle, and the lid can be lifted without contacting the hot surface of the lid 12. FIG. 10 shows the same handle 200 on a smaller diameter lid 12.

The handle 100 upper portion 120 as shown in FIGS. 3-6 shows left and right upwardly extending portions on a single central post 140. The handle 200 upper portions 220 as shown in FIGS. 7-10 shows left and right upwardly extending portions on a pair of lower post with a centrally located cross handle 240. However, the shape of the handle and the shape of the extensions in each embodiment are of lesser relevance. Of greater importance is the length “L¹” of the extensions 120, 220, the length “L²” of the central portion 140, 240 and the total length (L¹+L²) necessary to place the resting lid at an appropriate angle for readily grabbing the handle 100, 200 attached to the lid to allow it to be readily lifted up from a surface. In preferred embodiments, the central portion 140 or lower portion 240 of the handle has a length L² of 1-2 inches, thus approximating the length of prior art handles. The upwardly extending extensions 120, 220 add and additional length L¹ of about 1-3 inches to the total handle length (L¹+L²) so as to provide and angle a when the lid is placed on a surface of approximately 25° to 50°. Because they also present two points of contact with a surface when mounted on a lid they prevent rolling of the lid on a surface when placed upside down.

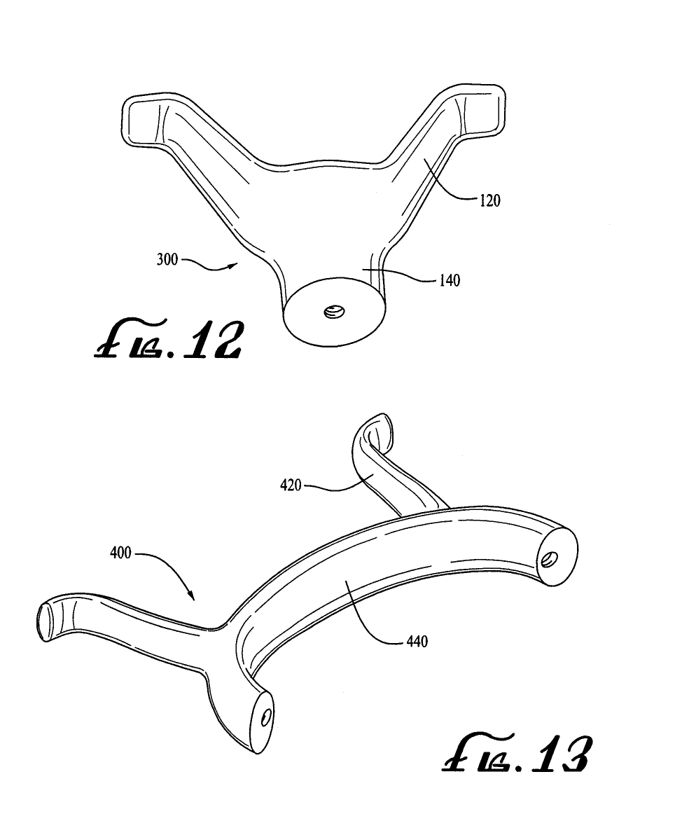

FIG. 12 is a perspective view of a handle 300 which is similar to the handle 100 shown in FIGS. 3-6. It has a center portion 140 and two extensions 120 extending upward and outward from the center portion 140 and has substantially the same dimensions and function as described for the embodiment of FIGS. 3-6. However, in contrast to FIGS. 3-6 the embodiment of FIG. 12 provides a unitary structure with more continuous and flowing contours.

FIG. 13 is a perspective view of a handle 400 which is similar to the handle 200 shown in FIGS. 7-10. The differences are that where the handle 200 has left and right upright posts with lower portions and upper extensions 220 and a center portion 240 between the upright posts, the handle 400 provides the left and right lower portions of the posts and the center portion 240 as a single continuously curved arched piece 440, preferably semicircular in shape. The extensions 420 then extend from spaced apart locations on the arch 440.

FIG. 11 shows each of the handle 100, 200 embodiments mounted on a lid 12 and resting on a flat surface. 11c corresponds to the embodiment of FIGS. 3-5 and 11d corresponds to the first handle embodiment mounted to a smaller lid as shown in FIG. 6. 11a corresponds to the embodiment of FIGS. 7-9 with 11b corresponds to the second handle embodiment mounted to a smaller lid as shown in FIG. 10. The angle a for the embodiments shown in a) and b) of FIG. 11 is 45-50°; the angle a for the embodiments shown in c) and d) of FIG. 11 is 25-30°. FIG. 11 would likewise be applicable to the embodiments of FIGS. 12 and 13 where the handle of FIG. 12 is applied to a pot lid in place of the embodiment of FIGS. 3-6, as shown in c) and d) of FIG. 11 and where the handle of FIG. 13 is applied to a pot lid in place of the embodiment of FIGS. 7-10, as shown in a) and b) of FIG. 11.

The handle incorporating features of the invention can be provided as original equipment mounted on a pot lid, or provided as a replacement handle for handles that are removable (held on by a bolt 11) from a lid and can be used to replace a knob handle which is typically bolted to the lid. In a further variation (not shown), extensions can be provided as attachments that can be mounted to existing handles.

I claim:

1. A handle for a pot lid, said handle extending a length above a central portion of said pot lid, such that when said pot lid is placed on a flat surface with said handle extended toward and in contact with the surface, and a surface portion of the pot lid is in contact with said surface the pot lid rests at an angle to said surface of greater than about 25°.

2. The handle of claim 1 wherein the handle extends above the central portion of the pot lid surface by 3 or more inches.

3. The handle of claim 1 wherein the length of the handle above the central portion of the pot lid surface is from about 3 inches to about 5 inches.

4. The handle of claim 1 wherein said handle comprises a central post having a length from about 1 inch to about 2 inches and one or more extensions extending upward from said central post, said one or more extensions extending from said central post adding an additional one to three inches to the length of the central post.

5. The handle of claim 1 wherein said handle comprises two upright posts mounted to the central portion of the lid, a cross piece between and attached to the upright posts, and extensions extending above the cross piece.

6. The handle of claim 5 wherein upper ends of the extensions are three to five inches above the central portion of the pot lid.

7. A handle for a pot lid comprising a central portion with two upwardly and outwardly spaced apart extensions integral therewith.

8. The handle for a pot lid of claim 7 wherein the central portion is post having a length of from about 1 inch to about 2 inches and the two extensions extending upward from said central post adding an additional one to three inches to the length of the pot lid handle.

9. A handle for a pot lid comprising a lower portion in the shape of an arch with bottom ends of said arch configured to mount to a central portion of a pot lid, an upper portion of said handle comprising two spaced apart posts extending upward from said arch.

10. The handle of claim 9 wherein the arch comprising the lower portion has two substantially vertical posts and a cross piece between and integral with the substantially vertical posts, the upper portion comprising upper posts extending above the arch such that upper ends of said upper posts are spaced three to five inches from bottom ends of said lower portion.

11. The handle of claim 9 wherein the arch comprising the lower portion is a continuously curving arch semicircular in shape and the upper portion comprises upwardly extending posts extending above the arch such that upper ends of said upwardly extending posts are spaced three to five inches from bottom ends of said lower portion.
